(19) United States
(12) Patent Application Publication
(10) Pub. No.: US 2010/0207979 A1
(43) Pub. Date: Aug. 19, 2010

(54) INKJET DRIVING CIRCUIT

(75) Inventors: Gorulko Dmytro, Suwon-si (KR); Ria Ju, Suwon-si (KR); Sangyoung Jin, Suwon-si (KR); Younghak Pyo, Suwon-si (KR); Seunghyuck Paek, Suwon-si (KR); Sangchul Seo, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/706,860

(22) Filed: Feb. 17, 2010

(30) Foreign Application Priority Data
Feb. 18, 2009 (KR) 10-2009-0013486

(51) Int. Cl. B41J 2/30; B41J 2/14; B41J 29/38

(52) U.S. Cl. 347/10; 347/68; 347/50

(57) ABSTRACT

An inkjet driving circuit capable of controlling the amount of ink discharged from nozzles by adjusting rising and falling slopes of head driving voltage through a digital variable resistor. The inkjet driving circuit includes a digital variable resistor adjusting rising and falling slopes of a head driving voltage outputted to an output terminal, a first transistor electrically coupled between the digital variable resistor and the output terminal and operating in response to a first pulse, and a second transistor electrically coupled to the output terminal and the first transistor and operating in response to a second pulse.

### CROSS-REFERENCE TO RELATED APPLICATION

This application claims priority to and the benefit of Korean Patent Application No. 10-2009-0013486, filed on Feb. 18, 2009, the entire content of which is incorporated herein by reference.

### BACKGROUND OF THE INVENTION

1. Field of the Invention

Aspects of the present invention relate to an inkjet driving circuit.

2. Description of the Related Art

In general, an inkjet head includes a plurality of nozzles formed with fine discharge holes for spraying ink. The inkjet head may be classified as either a piezoelectric inkjet head or a thermal inkjet head.

In the thermal inkjet head, heating elements corresponding to the nozzles are expanded by heat, so that ink is sprayed out of the nozzles and onto a print medium. In the piezoelectric inkjet head, voltage is applied to the nozzles through a voltage source to cause pressure generated by vibration of piezoelectric elements to vibrate, so that ink is sprayed onto a print medium out of the nozzles.

In both the thermal inkjet head and the piezoelectric inkjet head, since the nozzles represent variations different from each other, instead of producing constant pressure displacement according to constant heat and voltage, the amount of ink discharged from each nozzle may vary.

In the piezoelectric inkjet head, the amount of ink discharged from the nozzles can be adjusted by varying the rise time, fall time, maximum value and pulse width of head driving voltage applied to the nozzles.

An inkjet driving circuit generating the head driving voltage in the conventional piezoelectric inkjet head adjusts the pulse width of the head driving voltage in response to an input pulse signal, and adjusts maximum output voltage according to the amplitude of the input pulse signal. However, since the rise and fall time of the head driving voltage generated from the inkjet driving circuit may not be precisely adjusted, limitation exists in improving resolving power by adjusting the amount of ink discharged from the nozzles.

### SUMMARY OF THE INVENTION

Aspects of the present invention provide an inkjet driving circuit, which can control the maximum value, rise time, fall time and pulse width of a head driving voltage capable of controlling the amount of ink discharged, and can control the rising and falling slopes of the head driving voltage through a digital variable resistor operating in response to a digital signal.

Another aspect of the present invention provides an inkjet driving circuit capable of precisely controlling the amount of ink discharged from a nozzle by adjusting a head driving voltage to improve resolving power.

An inkjet driving circuit, according to aspects of the present invention, includes a digital variable resistor adjusting rising and falling slopes of a head driving voltage outputted to an output terminal, a first transistor, electrically coupled between the digital variable resistor and the output terminal and operating in response to a first pulse, and a second transistor, electrically coupled to the output terminal and the first transistor and operating in response to a second pulse.

The digital variable resistor adjusts the rising and falling slopes of the head driving voltage outputted to the output terminal by receiving a digital signal and applying a voltage to the first and second transistors, wherein the applied voltage corresponds to a resistance varied by the digital signal, to the first and second transistors.

The first pulse adjusts a fall time of the head driving voltage outputted to the output terminal, and the second pulse adjusts a rise time of the head driving voltage outputted to the output terminal of the inkjet driving circuit.

The inkjet driving circuit further includes a piezoelectric element electrically coupled between the output terminal and a ground terminal. The piezoelectric element is charged if the first transistor is turned on and the second transistor is turned off, and wherein the piezoelectric element is discharged if the first transistor is turned off and the second transistor is turned on.

The inkjet driving circuit further includes a first input switch electrically coupled to the first transistor to apply the first pulse to the first transistor, and a second input switch electrically coupled to the second transistor to apply the second pulse to the second transistor.

An inkjet driving circuit, according to aspects of the present invention, includes a digital variable resistor that adjusts rising and falling slopes of head driving voltage outputted to an output terminal, a first transistor including a first electrode, a second electrode and a control electrode, and operating in response to a second input voltage applied to the control electrode of the first transistor, the first electrode of the first transistor being electrically coupled to the digital variable resistor, the second electrode of the first transistor being electrically coupled to the output terminal and a piezoelectric element, a second transistor including a first electrode, a second electrode and a control electrode, and operating in response to a first input voltage applied to the control electrode of the second transistor, the first electrode of the second transistor being electrically coupled to the digital variable resistor, and a third transistor including a first electrode, a second electrode and a control electrode, the first electrode of the third transistor being electrically coupled to the second electrode of the first transistor, the output terminal and the piezoelectric element, the control electrode of the third transistor being electrically coupled to the second electrode of the second transistor.

The digital variable resistor adjusts the rising and falling slopes of the head driving voltage outputted to the output terminal by receiving a digital signal to vary voltage applied to the first electrode of the first transistor and the first electrode of the second transistor.

The first input voltage is used to adjust the falling slope of the head driving voltage outputted to the output terminal and the second input voltage is used to adjust a pulse width of the head driving voltage.

The inkjet driving circuit further includes a first resistor electrically coupled between the digital variable resistor and the first electrode of the first transistor to adjust the rising slope of the head driving voltage, and a second resistor electrically coupled between the digital variable resistor and the first electrode of the second transistor to adjust the falling slope of the head driving voltage.

The inkjet driving circuit further includes a third resistor electrically coupled to the control electrode of the first transistor to receive the second input voltage, and a fourth resistor electrically coupled to the control electrode of the second transistor to receive the first input voltage.

The inkjet driving circuit further includes a fifth resistor electrically coupled to a first supply voltage line to apply the first input voltage to the first transistor, and a sixth resistor electrically coupled to the first supply voltage line to apply the first input voltage to the second transistor.

The inkjet driving circuit further includes a seventh resistor electrically coupled between the control electrode of third second transistor and a second supply voltage line, and an eighth resistor electrically coupled between the second electrode of third second transistor and the second supply voltage line.

The inkjet driving circuit further includes a first resistor electrically coupled between the digital variable resistor and the first electrode of the first transistor to adjust the rising slope of the head driving voltage, a second resistor electrically coupled between the digital variable resistor and the first electrode of the second transistor to adjust the falling slope of the head driving voltage, a third resistor electrically coupled to the control electrode of the first transistor to receive the second input voltage, a fourth resistor electrically coupled to the control electrode of the second transistor to receive the first input voltage, a fifth resistor electrically coupled to the third resistor and a first supply voltage line to apply the first supply voltage to the third resistor, a sixth resistor electrically coupled to the fourth resistor and the first supply voltage line to apply the first supply voltage to the fourth resistor, a seventh resistor electrically coupled between the control electrode of third second transistor and a second supply voltage line, and an eighth resistor electrically coupled between the second electrode of third second transistor and the second supply voltage line.

The piezoelectric element is discharged if the first transistor is turned on, and is charged if the second and third transistors are turned on.

According to aspects of the present invention described above, the inkjet driving circuit can control the maximum value, rise time, fall time and pulse width of the head driving voltage capable of controlling the discharge amount of ink, and can control the rising and falling slopes of the head driving voltage through the digital variable resistor operating in response to the digital signal.

Further, the inkjet driving circuit, according to aspects of the present invention, can precisely control the amount of ink discharged from a nozzle by adjusting the head driving voltage to improve resolving power.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram schematically illustrating an inkjet printing system according to aspects of the present invention;

FIG. 2 is a circuit diagram illustrating an inkjet driving circuit according to an embodiment of the present invention;

FIG. 3 is a timing diagram illustrating the operation of the inkjet driving circuit of FIG. 2;

FIG. 4 is a circuit diagram illustrating an inkjet driving circuit according to another embodiment of the present invention; and

FIG. 5 is a timing diagram illustrating the operation of the inkjet driving circuit of FIG. 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, when an element is referred to as being electrically coupled to another element, the element can be directly coupled to another element or an intervening element may also be present therein.

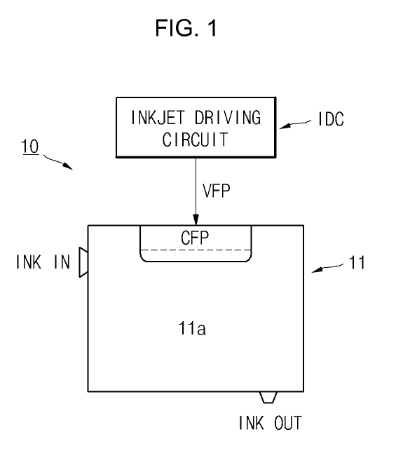

FIG. 1 is a block diagram schematically illustrating an inkjet printing system according to aspects of the present invention.

As illustrated in FIG. 1, the inkjet printing system 10 is a piezoelectric inkjet printing system, and includes a plurality of nozzles, wherein each nozzle 11 is provided in a head and has a piezoelectric element CFP, which may be a capacitor, and a corresponding inkjet driving circuit IDC. Each nozzle 11 sprays the same amount of ink in response to head driving voltage VFP.

Each nozzle 11 is electrically coupled to the inkjet driving circuit IDC to receive the head driving voltage VFP applied from the inkjet driving circuit IDC, and sprays or receives the ink. If the pulse type head driving voltage VFP is applied to the nozzle 11 from the inkjet driving circuit IDC, the piezoelectric element CFP is expanded, so that the ink is discharged from a chamber 11a of the nozzle 11 to an output terminal INK OUT. Further, if the pulse type head driving voltage VFP is not applied from the inkjet driving circuit IDC, the piezoelectric element CFP is contracted, so that the ink is supplied to the nozzle 11 from an ink reservoir through an input terminal INK IN of the chamber 11a. The nozzle 11 operates in response to the pulse waveform of the head driving voltage VFP.

The inkjet driving circuit IDC is electrically coupled to the nozzle 11 disposed on the head to apply the head driving voltage VFP to the nozzle 11, thereby adjusting the amount of the ink discharged from the nozzle 11. In other words, the amount of the ink discharged from the nozzle 11 can be controlled by adjusting the rise time, fall time, maximum value and pulse width of the head driving voltage VFP. That is, the amount of the ink discharged from each nozzle 11 provided in the head can be adjusted in response to the pulse waveform of the head driving voltage VFP applied from the inkjet driving circuit IDC.

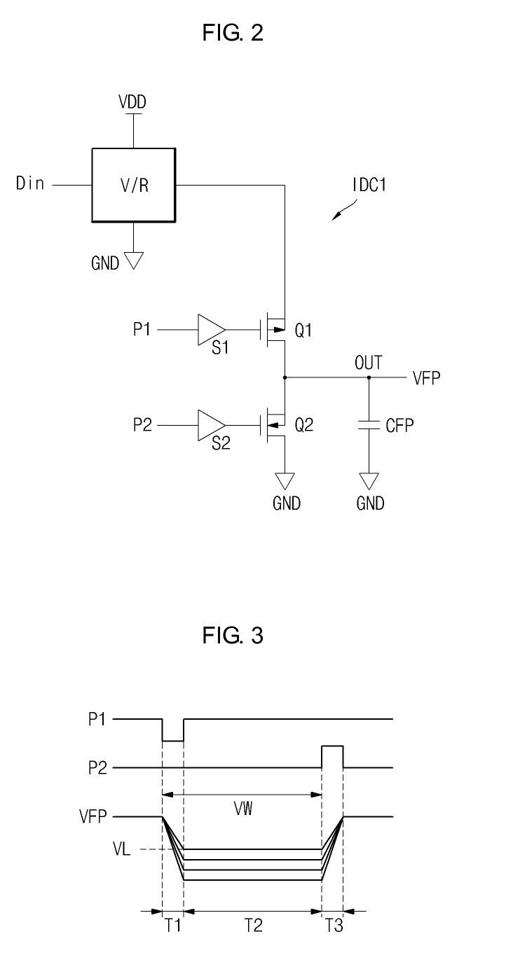

The inkjet driving circuit IDC, according to aspects of the present invention, is shown in detail in FIGS. 2 and 3, and will be described in detail with reference to FIGS. 2 to 5.

FIG. 2 is a circuit diagram illustrating the inkjet driving circuit according to an embodiment of the present invention.

As illustrated in FIG. 2, the inkjet driving circuit IDC1 includes a digital variable resistor V/R, a first transistor Q1 and a second transistor Q2. The inkjet driving circuit IDC1 may further include a first input switch S1, a second input switch S2 and the piezoelectric element CFP.

The digital variable resistor V/R receives a digital signal Din to apply a voltage corresponding to a resistance varied by the digital signal Din, to the first and second transistors Q1 and Q2. The digital variable resistor V/R is electrically coupled to the supply voltage line VDD and the ground GND to receive supply voltage and ground voltage. The supply voltage in this instance is a negative voltage and may be lower than the ground voltage.

When the pulse type head driving voltage VFP is output through the first and second transistors Q1 and Q2, the digital variable resistor V/R controls a rising slope and a falling slope of the head driving voltage VFP. In detail, the digital variable resistor V/R adjusts the rising slope and the falling slope of the head driving voltage VFP outputted to an output terminal OUT, thereby adjusting the slope of the head driving voltage VFP. Thus, the digital variable resistor V/R can adjust the rising slope and the falling slope of the head driving voltage VFP output to the output terminal OUT in response to the digital signal Din, thereby controlling the maximum value of the head driving voltage VFP. Thus, the amount of ink discharged from the head can be adjusted.

The first transistor Q1 includes a first electrode, a second electrode and a control electrode. The first electrode is electrically coupled to the digital variable resistor V/R, the second electrode is electrically coupled to the second transistor Q2 and the output terminal OUT, and the control electrode is electrically coupled to the first input switch S1. The first transistor Q1 operates in response to a first pulse P1 applied through the first input switch S1, so that the fall time of the head driving voltage VFP output to the output terminal OUT can be controlled.

The first transistor Q1 is turned on when the first pulse P1 is at a low level, and turned off when the first pulse P1 is at a high level. In detail, if the first pulse P1 at the low level is applied, the first transistor Q1 is turned on and the piezoelectric element CFP electrically coupled to the output terminal OUT is charged, so that the head driving voltage VFP falls. At this time, if a resistance value of the digital variable resistor V/R is increased, the falling slope of the head driving voltage VFP becomes larger. In contrast, if the resistance value of the digital variable resistor V/R is reduced, the falling slope of the head driving voltage VFP becomes smaller. That is, since the falling slope of the head driving voltage VFP varies depending on the resistance value of the digital variable resistor V/R, the amount of the ink discharged from the nozzle 11 can be controlled by adjusting the resistance value of the digital variable resistor V/R. The first transistor Q1 can be prepared in the form of a switching mode transistor. However, aspects of the present invention are not limited thereto.

The second transistor Q2 includes a first electrode, a second electrode and a control electrode. The first electrode is electrically coupled to the first transistor Q1 and the output terminal OUT, the second electrode is electrically coupled to the ground GND, and the control electrode is electrically coupled to the second input switch S2. The second transistor Q2 operates in response to a second pulse P2 applied through the second input switch S2, so that the rise time of the head driving voltage VFP output to the output terminal OUT can be controlled.

The second transistor Q2 is turned on when the second pulse P2 is at a high level, and turned off when the second pulse P2 is at a low level. In detail, if the second pulse P2 at the high level is applied, the second transistor Q2 is turned on and the piezoelectric element CFP electrically coupled to the output terminal OUT is discharged, so that the head driving voltage VFP rises. At this time, if the resistance value of the digital variable resistor V/R is increased, the rising slope of the head driving voltage VFP becomes larger. In contrast, if the resistance value of the digital variable resistor V/R is reduced, the rising slope of the head driving voltage VFP becomes smaller. That is, since the rising slope of the head driving voltage VFP varies depending on the resistance value of the digital variable resistor V/R, the amount of the ink discharged from the nozzle 11 can be controlled by adjusting the resistance value of the digital variable resistor V/R. The second transistor Q2 can be prepared in the form of the switching mode transistor. However, aspects of the present invention are not limited thereto.

The first input switch S1 is electrically coupled to the control electrode of the first transistor Q1 to receive the first pulse P1. The first input switch S1 applies the first pulse P1 to the first transistor Q1 or prevents the first pulse P1 from being applied to the first transistor Q1, thereby controlling turning on or off of the first transistor Q1.

The second input switch S2 is electrically coupled to the second transistor Q2 to receive the second pulse P2. The second input switch S2 applies the second pulse P2 to the second transistor Q2 or prevents the second pulse P2 from being applied to the second transistor Q2, thereby controlling a turning on or a turning off of the second transistor Q2.

The piezoelectric element CFP is electrically coupled between the output terminal OUT and the ground GND. In detail, the piezoelectric element CFP is provided to the nozzle 11 of the head, and charged or discharged by the pulse type head driving voltage VFP output to the output terminal OUT, so that the amount of the ink discharged from the nozzle 11 is controlled.

The inkjet driving circuit IDC1 controls the fall time of the head driving voltage VFP in response to the first pulse P1 applied to the control electrode of the first transistor Q1, and controls the rise time of the head driving voltage VFP in response to the second pulse P2 applied to the control electrode of the second transistor Q2. Thus, the pulse width of the head driving voltage VFP can be controlled by adjusting an interval between input time of the first pulse P1 at the low level and input time of the second pulse P2 at the high level.

Further, the inkjet driving circuit IDC1 can vary the resistance value of the digital variable resistor V/R in response to the digital signal Din, thereby precisely adjusting the falling and rising slopes of the pulse type head driving voltage VFP. Thus, the inkjet driving circuit IDC1 can adjust the maximum value of the head driving voltage VFP.

According to aspects of the invention described above, the inkjet driving circuit IDC1 can control the rise time, fall time, maximum value and pulse width of the head driving voltage VFP capable of controlling the discharge amount of the ink, and can control the rising and falling slopes of the head driving voltage VFP through the digital variable resistor V/R, thereby precisely controlling the amount of the ink discharged from the nozzle to improve resolving power.

FIG. 3 is a timing diagram illustrating the operation of the inkjet driving circuit of FIG. 2.

As illustrated in FIG. 3, the inkjet driving circuit includes a first driving time period T1, a second driving time period T2 and a third driving time period T3.

During the first driving time period T1, the head driving voltage VFP falls, the first pulse P1 is applied to the first transistor Q1, through the first input switch S1, at a low level, and the second pulse P2 is applied to the second transistor Q2, through the second input switch S2, at a low level. Further, the first transistor Q1 is turned on and the piezoelectric element CFP is charged. When the first driving time period T1 is constant, if the resistance value of the digital variable resistor V/R is increased, the falling slope of the head driving voltage VFP becomes larger, so that the maximum value VL of the head driving voltage VFP is increased. Further, if the first driving time period T1, during which the first pulse P1 is applied at the low level, becomes longer, the fall time of the head driving voltage VFP is increased. In contrast, if the first driving time period T1 becomes shorter, the fall time of the head driving voltage VFP is reduced. As described above, the first pulse P1 is maintained at the low level during the first driving time period T1, so that the fall time of the head driving voltage VFP can be controlled.

During the second driving time period T2, the head driving voltage VFP is constantly maintained, the first pulse P1 is applied to the first transistor Q1, through the first input switch S1, at a high level, and the second pulse P2 applied to the second transistor Q2 through the second input switch S2 is at the low level. Further, the piezoelectric element CFP maintains the voltage charged during the first driving time period T1. Since the second driving time period T2 is maintained before the level of the second pulse P2 is shifted to a high level, the pulse width VW of the head driving voltage VFP can be controlled according to the second driving time period T2. The pulse width VW corresponds to the time period before the first pulse P1 is applied at the high level and the second pulse P2 is applied at the high level.

During the third driving time period T3, the head driving voltage VFP rises, the first pulse P1 is applied to the first transistor Q1, through the first input switch S1, at the high level, and the second pulse P2 is applied to the second transistor Q2, through the second input switch S2, at a high level. Further, the second transistor Q2 is turned on and the voltage charged in the piezoelectric element CFP during the first driving time period T1 is discharged. When the third driving time period T3 is constant, if the resistance value of the digital variable resistor V/R is increased, the rising slope of the head driving voltage VFP becomes larger. Further, if the third driving time period T3, during which the second pulse p2 at the high level is applied, becomes longer, the rise time of the head driving voltage VFP is increased. In contrast, if the first driving time period T1 becomes shorter, the rise time of the head driving voltage VFP is reduced. As described above, the second pulse P2 is maintained at the high level during the third driving time period T3, so that the rise time of the head driving voltage VFP can be controlled.

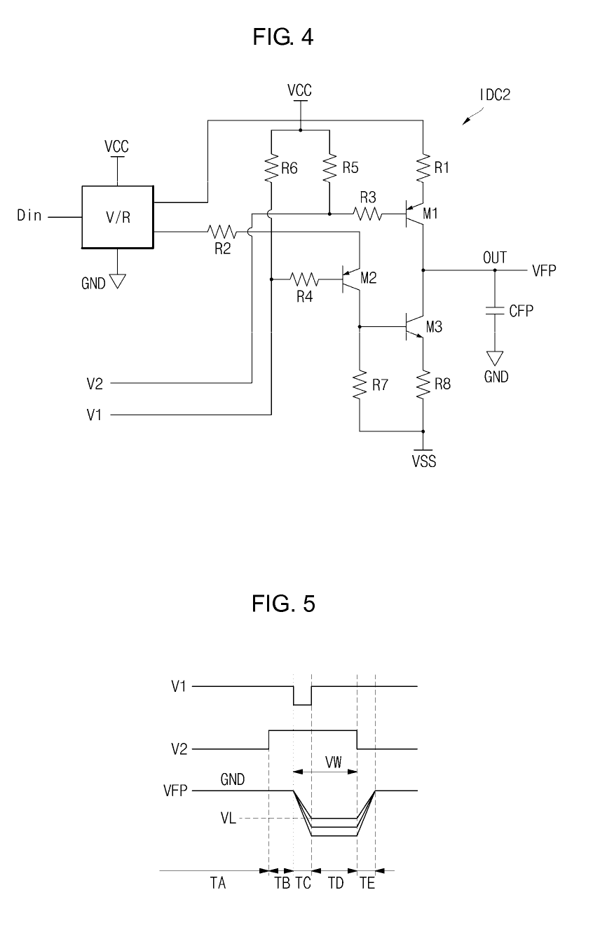

FIG. 4 is a detailed circuit diagram illustrating an inkjet driving circuit according to another embodiment of the present invention

As illustrated in FIG. 4, the inkjet driving circuit IDC2 includes a digital variable resistor V/R and first to third transistors M1 to M3. The inkjet driving circuit IDC2 may further include first to eighth resistors R1 to R8 and a piezoelectric element CFP.

The digital variable resistor V/R receives a digital signal Din to apply a voltage, which corresponds to a resistance varied by the digital signal Din, to a first electrode of the first transistor M1 and a first electrode of the second transistor M2. The digital variable resistor V/R is electrically coupled to the first supply voltage line VCC and the ground GND to receive first supply voltage and ground voltage. The first supply voltage may be higher than the ground voltage.

The digital variable resistor V/R is electrically coupled to the first and second resistors R1 and R2 to vary the voltage, which is applied to the first electrodes of the first and second transistors M1 and M2 through the first and second resistors R1 and R2, in correspondence with the digital variable resistor V/R.

The voltage applied to the first electrodes of the first and second transistors M1 and M2 can be varied by changing the resistance value of the digital variable resistor V/R. Thus, the amplitude of the head driving voltage VFP, which is outputted to an output terminal OUT through the first and second transistors M1 and M2 and rises or falls per unit time, can be controlled. That is, the digital variable resistor V/R can control the rising and falling slopes of the pulse type head driving voltage VFP output to the output terminal OUT.

As described above, the digital variable resistor V/R can control the slopes of the head driving voltage VFP output to the output terminal OUT by varying the resistance value thereof, so that the amount of the ink discharged from the head can be adjusted.

The first transistor M1 includes the first electrode (source or emitter), a second electrode (drain or collector), and a control electrode (gate or base). The first electrode is electrically coupled to the first resistor R1, the second electrode is electrically coupled to a first electrode (drain or collector) of the third transistor M3, the output terminal OUT and the piezoelectric element CFP, and the control electrode is electrically coupled to the third resistor R3.

The first transistor M1 is turned on or off in response to second input voltage V2 input through the third resistor R3 electrically coupled to the control electrode. The first transistor M1 can be prepared as a P channel type or PNP type transistor which is turned off when the second input voltage V2 is applied at a high level and turned on when the second input voltage V2 is applied at a low level.

The digital variable resistor V/R is electrically coupled to the first electrode of the first transistor M1 through the first resistor R1, which is electrically coupled to the first electrode. Thus, the head driving voltage VFP is outputted at the output terminal OUT, which is electrically coupled to the second electrode of the first transistor M1, and the head driving voltage VFP can be controlled according to the digital variable resistor V/R. In other words, the first resistor R1 and the digital variable resistor V/R, which is electrically coupled to the first electrode of the first transistor M1, can control the rising slope of the head driving voltage VFP, which is outputted to the second electrode of the first transistor M1. At this time, the piezoelectric element CFP, which is electrically coupled between the output terminal OUT and the ground GND, can be discharged.

The second transistor M2 includes the first electrode (source or emitter), a second electrode (drain or collector), and a control electrode (gate or base). The first electrode is electrically coupled to the second resistor R2, the second electrode is electrically coupled to a control electrode (gate or base) of the third transistor M3, and the seventh resistor R7, and the control electrode is electrically coupled to the fourth resistor R4.

The second transistor M2 is turned on or off in response to first input voltage V1 input through the fourth resistor R4. The third transistor M3 operates according to the turning on or off of the second transistor M2. The second transistor M2 can be a P channel type or PNP type transistor which is turned off when the first input voltage V1 is applied at a high level and turned on when the first input voltage V1 is applied at a low level.

Further, the first electrode of the second transistor M2 receives a voltage corresponding to the digital variable resistor V/R, wherein the digital variable resistor V/R is electrically coupled to the second resistor R2 which is electrically coupled to the first electrode of the second transistor M2. Thus, voltage applied to the third transistor M3 can be controlled according to the digital variable resistor V/R. In other words, the second resistor R2 and the digital variable resistor V/R, which is electrically coupled to the first electrode of the second transistor M2, can control the falling slope of the head driving voltage VFP which is outputted to the output terminal OUT through the third transistor M3. Thus, the piezoelectric element CFP, which is electrically coupled between the output terminal OUT and the ground GND, can be charged.

The third transistor M3 includes the first electrode (drain or collector), a second electrode (source or emitter), and the control electrode (gate or base). The first electrode is electrically coupled to the second electrode (drain or collector) of the first transistor M1, the output terminal OUT and the piezoelectric element CFP. The second electrode is electrically coupled to the eighth resistor R8 and the control electrode is electrically coupled to the second electrode of the second transistor M2 and the seventh resistor R7.

The third transistor M3 is turned on or off through the second transistor M2, which is electrically coupled to the second electrode of the third transistor M3. If the second transistor M2 is turned on, the third transistor M3 is turned on by voltage applied to the control electrode of the third transistor M3 through the second transistor M2. In contrast, if the second transistor M2 is turned off, the third transistor M3 is turned off by the voltage applied to the control electrode of the third transistor M3 through the second transistor M2. The third transistor M3 can be prepared as an N channel type or NPN type transistor.

If the third transistor M3 is turned on, a second supply voltage applied through a second supply voltage line VSS, which is electrically coupled to the second electrode of the third transistor M3, can be charged in the piezoelectric element CFP electrically coupled to the output terminal OUT. The second supply voltage is negative voltage and may be lower than the ground voltage. The time period during which the piezoelectric element CFP is charged through the third transistor M3 corresponds to the time period during which the head driving voltage VFP falls. Thus, the falling slope of the head driving voltage VFP can be controlled according to the digital variable resistor V/R, which is electrically coupled to the control electrode of the third transistor M3 through the second transistor M2.

The first resistor R1 is electrically coupled to the digital variable resistor V/R and the first transistor M1, so that voltage corresponding to sum of the resistance value of the digital variable resistor V/R and the resistance value of the first resistor R1 is applied to the first electrode of the first transistor M1. Thus, the rising slope of the head driving voltage VFP output to the output terminal OUT through the first transistor M1 can be controlled by varying the resistance value of the digital variable resistor V/R electrically coupled to the first resistor R1.

The second resistor R2 is electrically coupled to the digital variable resistor V/R and the second transistor M2, so that voltage corresponding to a sum of the resistance value of the digital variable resistor V/R and the resistance value of the second resistor R2 is applied to the first electrode of the second transistor M2. Thus, the voltage applied to the control electrode of the third transistor M3 can be controlled by varying the resistance value of the digital variable resistor V/R.

The third resistor R3 is electrically coupled to the control electrode of the first transistor M1 to receive the second input voltage V2. In other words, the third resistor R3 is an input resistor and adjusts the second input voltage V2 in order to apply the second input voltage V2 to the control electrode of the first transistor M1.

The fourth resistor R4 is electrically coupled to the control electrode of the second transistor M2 to receive the first input voltage V1. That is, the fourth resistor R4 is an input resistor and adjusts the first input voltage V1 to apply the first input voltage V1 to the control electrode of the second transistor M2.

The fifth resistor R5 includes a first electrode electrically coupled to the first supply voltage line VCC, and a second electrode electrically coupled to the third resistor R3 to receive the second input voltage V2. The fifth resistor R5 determines the voltage applied to the control electrode of the first transistor M1 in response to the first supply voltage applied to the first electrode and the second input voltage V2, which is applied to the second electrode.

The sixth resistor R6 includes a first electrode electrically coupled to the first supply voltage line VCC, and a second electrode electrically coupled to the fourth resistor R4 to receive the first input voltage V1. The sixth resistor R6 determines the voltage applied to the control electrode of the second transistor M2 in response to the first supply voltage applied to the first electrode and the first input voltage V1 applied to the second electrode.

The seventh resistor R7 includes a first electrode electrically coupled to the second electrode of the second transistor M2 and the control electrode of the third transistor M3, and a second electrode electrically coupled to the second supply voltage line VSS. If the second transistor M2 is turned on, the seventh resistor R7 can be electrically coupled to the second resistor R2 and the digital variable resistor V/R, which is electrically coupled to the first electrode of the second transistor M2. Thus, the seventh resistor R7 determines the voltage applied to the control electrode of the third transistor M3 in response to the voltage applied through the second transistor M2 and the second supply voltage applied through the second supply voltage line VSS.

The eighth resistor R8 is electrically coupled between the second electrode of the third transistor M3 and the second supply voltage line VSS. Thus, the eighth resistor R8 can determine the voltage applied to the output terminal OUT and the piezoelectric element CFP electrically coupled to the first electrode of the third transistor M3.

The piezoelectric element CFP is electrically coupled between the output terminal OUT and the ground GND. In other words, the piezoelectric element CFP is provided to the nozzle 11 of the head, and charged or discharged by the pulse type head driving voltage VFP output to the output terminal OUT, so that the amount of the ink discharged from the nozzle 11 is controlled.

The inkjet driving circuit IDC2 can control the pulse width of the head driving voltage VFP in response to the second input voltage V2 applied to the control electrode of the first transistor M1, and can control the fall time of the head driving voltage VFP in response to the first input voltage V1 applied to the control electrode of the second transistor M2.

Further, the inkjet driving circuit IDC2 can vary the resistance value of the digital variable resistor V/R in response to the digital signal Din, thereby precisely adjusting the falling and rising slopes of the pulse type head driving voltage VFP.

Furthermore, the inkjet driving circuit IDC2 can adjust the rising and falling slopes of the head driving voltage VFP through the digital variable resistor V/R, thereby adjusting the maximum value of the head driving voltage VFP.

According to aspects of the present invention, as described above, the inkjet driving circuit IDC2 can control the rise time, fall time, maximum value and pulse width of the head driving voltage VFP capable of controlling the discharge amount of the ink, and can control the rising and falling slopes of the head driving voltage VFP through the digital variable resistor V/R, thereby precisely controlling the amount of the ink discharged from the nozzle to improve resolving power.

FIG. 5 is a timing diagram illustrating the operation of the inkjet driving circuit of FIG. 4.

As illustrated in FIG. 5, the inkjet driving circuit includes a first driving time period TA, a second driving time period TB, a third driving time period TC, a fourth driving time period TD and a fifth driving time period TE.

During the first driving time period TA, the first input voltage V1 is applied at a high level and the second input voltage V2 is applied at a low level to the inkjet driving circuit IDC2. In other words, the first input voltage V1 is applied at the high level to the second transistor M2, through the fourth resistor R4, so that the second and third transistors M2 and M3 are turned off. The second input voltage V2 is applied at the low level to the first transistor M1, through the third resistor R3, so that the first transistor M1 is turned on. Thus, the voltage charged in the piezoelectric element CFP is discharged, and the head driving voltage VFP can be maintained at the ground voltage GND.

During the second driving time period TB, the first input voltage V1 is applied at the high level and the second input voltage V2 is applied at a high level to the inkjet driving circuit IDC2. That is, the first input voltage V1 is applied at the high level to the second transistor M2, through the fourth resistor R4, so that the second and third transistors M2 and M3 are turned off. The second input voltage V2 is applied at the high level to the first transistor M1, through the third resistor R3, so that the first transistor M1 is turned off. Thus, the head driving voltage VFP can be continuously maintained at the ground voltage GND before the level of the first input voltage V1 is shifted to a low level.

During the third driving time period TC, the first input voltage V1 is applied at the low level and the second input voltage V2 is applied at the high level to the inkjet driving circuit IDC2. In other words, the first input voltage V1 is applied at the low level to the second transistor M2, through the fourth resistor R4, so that the second and third transistors M2 and M3 are turned on. The second input voltage V2 is applied at the high level to the first transistor M1, through the third resistor R3, so that the first transistor M1 is turned off.

Thus, the second supply voltage from the second supply voltage line VSS, which corresponds to the voltage between the control electrode and the second electrode of the third transistor M3, is applied to the output terminal OUT, through the third transistor M3, so that the piezoelectric element CFP is charged with the second supply voltage. Thus, the head driving voltage VFP falls during the third driving time period TC. That is, the head driving voltage VFP has the fall time during the third driving time period TC for which the first input voltage V1 is at the low level. At this time, the voltage applied to the second transistor M2, through the second resistor R2, is varied by the digital variable resistor V/R, and the falling slope of the head driving voltage VFP can be controlled according to the digital variable resistor V/R.

For example, if the resistance value of the digital variable resistor V/R is increased, since the slope of the head driving voltage VFP becomes larger, the maximum value VL of the head driving voltage VFP has a large negative value. Thus, the amount of ink discharged is increased. That is, when the head driving voltage VFP has the constant fall time, the falling slope of the head driving voltage VFP is adjusted through the digital variable resistor V/R so that the maximum value VL of the head driving voltage VFP can also be adjusted.

During the fourth driving time period TD, the first input voltage V1 is applied at the high level and the second input voltage V2 is applied at the high level to the inkjet driving circuit IDC2. In other words, the first input voltage V1 is applied at the high level to the second transistor M2, through the fourth resistor R4, so that the second and third transistors M2 and M3 are turned off. The second input voltage V2 is applied at the high level to the first transistor M1, through the third resistor R3, so that the first transistor M1 is turned off. Thus, the head driving voltage VFP output to the output terminal OUT continuously maintains the maximum value VL during the fourth driving time period TD before the level of the second input voltage V2 is shifted to a low level.

During the fifth driving time period TE, the first input voltage V1 is applied at the high level and the second input voltage V2 is applied at the low level to the inkjet driving circuit IDC2. In other words, the first input voltage V1 is applied at the high level to the second transistor M2, through the fourth resistor R4, so that the second and third transistors M2 and M3 are turned off. The second input voltage V2 is applied at the low level to the first transistor M1, through the third resistor R3, so that the first transistor M1 is turned on.

Thus, the voltage charged to the piezoelectric element CFP, during the third driving time period TC, is discharged. Thus, the head driving voltage VFP output to the output terminal OUT rises during the fifth driving time period TE. That is, the head driving voltage VFP has the rise time during the fifth driving time period TE after the level of the second input voltage V2 is shifted to the low level. At this time, the voltage applied to the first transistor M1, through the first resistor R1, is varied through the digital variable resistor V/R, and the rising slope of the head driving voltage VFP can be controlled according to the digital variable resistor V/R. For example, if the resistance value of the digital variable resistor V/R is increased, the slope of the head driving voltage VFP becomes larger and the amount of ink discharged is increased.

Although the embodiments of the present invention have been described in detail hereinabove, it should be understood that many variations and modifications of the basic inventive concept herein described will still fall within the spirit and scope of the present invention as defined in the appended claims.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An inkjet driving circuit comprising:
a digital variable resistor adjusting rising and falling slopes of a head driving voltage outputted to an output terminal of the inkjet driving circuit;
a first transistor electrically coupled between the digital variable resistor and the output terminal and operating in response to a first pulse; and
a second transistor electrically coupled to the output terminal and the first transistor and operating in response to a second pulse.

2. The inkjet driving circuit of claim 1, wherein the digital variable resistor adjusts the rising and falling slopes of the head driving voltage outputted to the output terminal by receiving a digital signal and applying a voltage to the first and second transistors, wherein the applied voltage corresponds to a resistance varied by the digital signal.

3. The inkjet driving circuit of claim 1, wherein the first pulse adjusts a fall time of the head driving voltage outputted to the output terminal, and the second pulse adjusts a rise time of the head driving voltage outputted to the output terminal.

4. The inkjet driving circuit of claim 1, further comprising a piezoelectric element electrically coupled between the output terminal and a ground terminal,
wherein the piezoelectric element is charged if the first transistor is turned on and the second transistor is turned off, and
wherein the piezoelectric element is discharged if the first transistor is turned off and the second transistor is turned on.

5. The inkjet driving circuit of claim 1, further comprising:
a first input switch electrically coupled to the first transistor to apply the first pulse to the first transistor; and
a second input switch electrically coupled to the second transistor to apply the second pulse to the second transistor.

6. An inkjet driving circuit comprising:
a digital variable resistor that adjusts rising and falling slopes of head driving voltage outputted to an output terminal;
a first transistor including a first electrode, a second electrode and a control electrode, and operating in response to a second input voltage applied to the control electrode of the first transistor, the first electrode of the first transistor being electrically coupled to the digital variable resistor, the second electrode of the first transistor being electrically coupled to the output terminal and a piezoelectric element;
a second transistor including a first electrode, a second electrode and a control electrode, and operating in response to a first input voltage applied to the control electrode of the second transistor, the first electrode of the second transistor being electrically coupled to the digital variable resistor; and
a third transistor including a first electrode, a second electrode and a control electrode, the first electrode of the third transistor being electrically coupled to the second electrode of the first transistor, the output terminal and the piezoelectric element, the control electrode of the third transistor being electrically coupled to the second electrode of the second transistor.

7. The inkjet driving circuit of claim 6, wherein the digital variable resistor adjusts the rising and falling slopes of the head driving voltage by receiving a digital signal to vary a voltage applied to the first electrode of the first transistor and the first electrode of the second transistor.

8. The inkjet driving circuit of claim 6, wherein the first input voltage is used to adjust the falling slope of the head driving voltage outputted to the output terminal and the second input voltage is used to adjust a pulse width of the head driving voltage.

9. The inkjet driving circuit of claim 6, further comprising:
a first resistor electrically coupled between the digital variable resistor and the first electrode of the first transistor to adjust the rising slope of the head driving voltage; and
a second resistor electrically coupled between the digital variable resistor and the first electrode of the second transistor to adjust the falling slope of the head driving voltage.

10. The inkjet driving circuit of claim 6, further comprising:
a third resistor electrically coupled to the control electrode of the first transistor to receive the second input voltage; and
a fourth resistor electrically coupled to the control electrode of the second transistor to receive the first input voltage.

11. The inkjet driving circuit of claim 6, further comprising:
a fifth resistor electrically coupled to a first supply voltage line to apply the first input voltage to the first transistor; and
a sixth resistor electrically coupled to the first supply voltage line to apply the first input voltage to the second transistor.

12. The inkjet driving circuit of claim 6, further comprising:
a seventh resistor electrically coupled between the control electrode of third second transistor and a second supply voltage line; and
an eighth resistor electrically coupled between the second electrode of third second transistor and the second supply voltage line.

13. The inkjet driving circuit of claim 6, further comprising:
a first resistor electrically coupled between the digital variable resistor and the first electrode of the first transistor to adjust the rising slope of the head driving voltage;
a second resistor electrically coupled between the digital variable resistor and the first electrode of the second transistor to adjust the falling slope of the head driving voltage;
a third resistor electrically coupled to the control electrode of the first transistor to receive the second input voltage;
a fourth resistor electrically coupled to the control electrode of the second transistor to receive the first input voltage;
a fifth resistor electrically coupled to the third resistor and a first supply voltage line to apply the first supply voltage to the third resistor;
a sixth resistor electrically coupled to the fourth resistor and the first supply voltage line to apply the first supply voltage to the fourth resistor;
a seventh resistor electrically coupled between the control electrode of third second transistor and a second supply voltage line; and
an eighth resistor electrically coupled between the second electrode of third second transistor and the second supply voltage line.

14. The inkjet driving circuit of claim 6, wherein the piezoelectric element is discharged if the first transistor is turned on, and is charged if the second and third transistors are turned on.

15. A method of driving a nozzle of an inkjet printer head of an image forming apparatus, the method comprising:
adjusting a resistance of a digital variable resistor according to a digital signal applied to the digital variable resistor;
adjusting a head driving voltage according to the adjusting the resistance of the digital variable resistor; and
driving the nozzle of the inkjet printer head according to the adjusted head driving voltage applied to an output terminal driving the nozzle.

16. The method of claim 15, wherein adjusting a head driving voltage comprises:
generating a first electrical pulse to turn on or turn off a first transistor to adjust a fall time of the head driving voltage; and
generating a second electrical pulse to turn on or turn off a second transistor to adjust a rise time of the head driving voltage,
wherein the first transistor is coupled between the digital variable resistor and the output terminal, and
wherein the second transistor is coupled to the first transistor and the output terminal.

17. The method of claim 16, wherein driving the nozzle of the inkjet printer head comprises:
charging a piezoelectric element, which is electrically coupled to the output terminal, by turning on the first transistor and turning off the second transistor; and
discharging the piezoelectric element by turning off the first transistor and turning on the second transistor.

18. The method of claim 15, wherein adjusting a head driving voltage comprises:
applying a second voltage to a control electrode of a first transistor also having a first electrode and a second electrode, the first electrode being electrically coupled to the digital variable resistor, the second electrode being electrically coupled to the output terminal and a piezoelectric element to store the adjusted head driving voltage;
applying a first input voltage to a control electrode of a second transistor also having a first electrode and a second electrode, the first electrode being electrically coupled to the digital variable resistor;
applying a third voltage to a control electrode of a third transistor also having a first electrode and a second electrode, the control electrode being electrically coupled to the second electrode of the second transistor, the first electrode being electrically coupled to the second electrode of the first transistor and being electrically coupled to the piezoelectric element and the output terminal to output the adjusted head driving voltage; and
varying the resistance of the digital variable resistor to adjust the rising and falling slopes of the head driving voltage by receiving the digital signal to vary a voltage applied to the first electrodes of the first transistor and first electrode of the second transistor.

19. The method of claim 18, further comprising:
adjusting a rising slope of the head driving voltage through a first resistor electrically coupled between the digital variable resistor and the first electrode of the first transistor;
adjusting a falling slope of the head driving voltage through a second resistor electrically coupled between the digital variable resistor and the first electrode of the second transistor;
receiving the second input voltage through a third resistor electrically coupled to the control electrode of the first transistor;
receiving the first input voltage through a fourth resistor electrically coupled to the control electrode of the second transistor;
applying the second input voltage to the first transistor through a fifth resistor electrically coupled to a first supply voltage line;
applying the first input voltage to the second transistor through a sixth resistor electrically coupled to the first supply voltage line;
electrically coupling a seventh resistor between the control electrode of third second transistor and a second supply voltage line; and
electrically coupling an eighth resistor electrically coupled between the second electrode of third second transistor and the second supply voltage line.

20. The method of claim 19, wherein driving the nozzle of the inkjet printer head comprises:
charging the piezoelectric element, which is electrically coupled to the output terminal, by turning on the second transistor and the third transistor; and
discharging the piezoelectric element by turning on the first transistor.

21. An inkjet driving circuit comprising:
a digital variable resistor adjusting rising and falling slopes of a head driving voltage outputted to an output terminal of the inkjet driving circuit; and
a voltage driving circuit driving the head driving voltage adjusted by the digital variable resistor to the output terminal of the inkjet driving circuit.

22. The inkjet driving circuit of claim 21, wherein the digital variable resistor adjusts the rising and falling slopes of the head driving voltage outputted to the output terminal by receiving a digital signal and applying a voltage to the voltage driving circuit, wherein the applied voltage corresponds to a resistance varied by the digital signal.

23. The inkjet driving circuit of claim 22, wherein the voltage driving circuit comprises
a charging circuit to charge a piezoelectric device with the applied voltage corresponding to the resistance varied by the digital signal; and
a discharging circuit to discharge the piezoelectric device with the applied voltage corresponding to the resistance varied by the digital signal.

24. The inkjet driving circuit of claim 23, wherein the charging circuit adjusts a rise time of the head driving voltage outputted to the output terminal, and the discharging circuit adjusts a fall time of the head driving voltage outputted to the output terminal.
